(19) United States
(12) Patent Application Publication
(10) Pub. No.: US 2010/0156129 A1
(43) Pub. Date: Jun. 24, 2010

(54) AUTOMOTIVE CENTER CONSOLE LID / ARMREST SLIDE BRACING SYSTEM

(76) Inventors: Gregg S. Evans, Windsor (CA); Chris Barney, Stering Heights, MI (US)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 12/641,148

(22) Filed: Dec. 17, 2009

Related U.S. Application Data
(60) Provisional application No. 61/138,824, filed on Dec. 18, 2008.

(51) Int. Cl. B60R 7/04; A47B 88/00

(52) U.S. Cl. 296/24.34; 384/18

(57) ABSTRACT

An automotive center console lid/armrest slide bracing system comprising a center console lid/armrest including a lid/armrest cover having a nose portion, a lid/armrest base, and a linear slide. The lid/armrest cover has at least one first wedge surface inside the lid/armrest cover that engages at least one first corresponding wedge surface on the lid/armrest base, when the center console lid/armrest is positioned fully rearward to lock the nose of the lid/armrest cover up and down to resist higher loading requirements when open.

### CROSS-REFERENCE TO RELATED APPLICATION(S)

This application claims the benefit of provisional patent application U.S. Ser. No. 61/138,824, filed Dec. 18, 2009, which is expressly incorporated herein by reference.

### BACKGROUND OF INVENTION

a. Field of Invention

The invention relates generally to automotive consoles, and more particularly, the invention relates to an automotive center console lid/armrest slide bracing system.

b. Description of Related Art

Automotive interiors are provided with various features and components to improve the comfort and convenience of vehicle occupants. For example, many automotive vehicles include a center console or other storage devices disposed between the driver and passenger seats in the front passenger compartment of the vehicle. Such consoles have many functions and may operate as an armrest, a storage unit, a writing table, a cup holder, or another suitable device. Such consoles typically include a console base either secured to the floor or pivotally connected between the seats, a storage cavity formed in the console base to retain items during travel and an armrest pivotally connected to the console base extending generally horizontally across the storage cavity. A console lid and armrest may be generally moveable from a first position in which the lid covers an opening to a storage compartment and wherein the armrest is in a substantially horizontal orientation convenient for occupants to rest their arms, and a second position wherein the armrest extends angularly away from the console to permit access to the storage compartment.

Automotive consoles having a sliding lid/armrest system are known. For example, FIG. 2 shows a related art sliding lid/armrest system 10 having two ball bearing drawer slides 12 contained in a console lid/armrest 14. Such known lid/sliding armrest systems typically include multiple ball bearing drawer slides that increase the complexity and cost of manufacture. Additionally, such known sliding lid/armrest systems with ball bearing drawer slides can be difficult to align and may have jamming issues.

It would therefore of benefit to provide an economical and efficient automotive center console lid/armrest slide bracing system that addresses the issues with existing systems and that minimizes and/or eliminates one or more of the above-identified deficiencies.

### SUMMARY OF THE INVENTION

The invention overcomes the deficiencies of prior art automotive console sliding lid/armrest systems by providing an automotive center console lid/armrest slide bracing system. The advantages of the invention are numerous and include, but are not limited to, simplification of an automotive center console lid/armrest slide bracing system or mechanism which reduces costs by having only one ball bearing slide instead of two ball bearing slides as is found in typical center console lid/armrest sliding systems. In addition, the invention eliminates alignment issues by avoiding two slide parallelism issues. With this invention the expense of the second ball bearing drawer slide is saved, and the difficulty in aligning twin slides is avoided.

In one of the embodiments of the invention, an automotive center console lid/armrest slide bracing system is provided. The system includes a center console lid/armrest having a lid/armrest cover with a nose portion, a lid/armrest base, and a ball bearing drawer type linear slide. The lid/armrest cover has at least one first wedge surface inside the lid/armrest cover that engages one or more first corresponding wedge surfaces on the lid/armrest base, when the center console lid/armrest is positioned fully rearward to lock the nose of the lid/armrest cover up and down to resist higher loading requirements when open. The lid/armrest cover may further have one or more second wedge surfaces on each side of the inside of the lid/armrest cover that engages one or more second corresponding second wedge surfaces on the lid/armrest base, when the center console lid/armrest is positioned fully rearward to lock the nose of the lid/armrest cover side to side to resist the higher loading requirements when open. The center console lid/armrest may have a plurality of grooves inside the lid/armrest cover, and the lid/armrest base may have one or more lid base protrusions on each side of the lid/armrest base, whereby the lid base protrusions of the lid/armrest base engage the grooves in the lid/armrest cover to form a slide track to provide additional roll control.

In another embodiment, the invention also provides an automotive center console lid/armrest slide bracing system including a center console lid/armrest including a lid/armrest cover having a nose portion, a lid/armrest base and a linear slide. The lid/armrest cover may include at least one first wedge surface that engages at least one first corresponding wedge surface of the lid/armrest base when the center console lid/armrest is positioned generally rearward to lock the nose of the lid/armrest cover from movement in a first predetermined direction to resist higher loading requirements when open.

For the automotive center console lid/armrest slide bracing system described above, the lid/armrest cover first wedge surface may be positioned inside the lid/armrest cover. In an embodiment, the first predetermined direction may be an up and down direction when the center console lid/armrest is positioned in an automobile. In an embodiment, the slide may be a ball bearing drawer slide.

For the automotive center console lid/armrest slide bracing system described above, in an embodiment, the lid/armrest cover has at least one second wedge surface on each side of the inside of the lid/armrest cover that engages an at least one second corresponding second wedge surface on the lid/armrest base when the center console lid/armrest is positioned generally rearward to lock the nose of the lid/armrest cover from movement in a second predetermined direction to resist the higher loading requirements when open. In an embodiment, the second predetermined direction may be a side to side direction when the center console lid/armrest is positioned in an automobile.

In an embodiment of the automotive center console lid/armrest slide bracing system described above, the center console lid/armrest may include a plurality of grooves inside the lid/armrest cover, and the lid/armrest base has at least one lid base protrusion on each side of the lid/armrest base. The lid base protrusions of the lid/armrest base may engage the grooves in the lid/armrest cover to form a slide track to provide additional roll control.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 is an environmental perspective view of an automotive interior, including an exemplary center console having an automotive center console lid/armrest slide bracing system according to the invention;

FIG. 2 is a perspective view of a related art sliding lid/armrest system having two ball bearing/gear drawer slides;

FIG. 3 is a side view of one of the embodiments of the automotive center console lid/armrest slide bracing system of the invention shown in a first operative position;

FIG. 4 is a side view of the automotive center console lid/armrest slide bracing system of FIG. 3 shown in a second operative position;

FIG. 5 is a side view of the automotive center console lid/armrest slide bracing system of FIG. 3 shown in a third operative position;

FIG. 6 a side view of the automotive center console lid/armrest slide bracing system of FIG. 5 showing typical severe lid load positions required in automotive testing;

FIG. 7 is a perspective view of one of the embodiments of the automotive center console lid/armrest slide bracing system of the invention showing the lid base protrusions and grooves;

FIG. 8 is a perspective view of one of the embodiments of the automotive center console lid/armrest slide bracing system of the invention showing wedge surfaces;

FIG. 9 is a view of the center console lid/armrest from below, sectioned to show the lid base protrusions in the slide tracks of one of the embodiments of the automotive center console lid/armrest slide bracing system of the invention;

FIG. 10 is a sectional front view of the one of the embodiments of the automotive center console lid/armrest slide bracing system of the invention when the lid/armrest cover is in a closed position;

FIG. 11 is a bottom view of the underside of the lid/armrest cover of the automotive center console lid/armrest slide bracing system of the invention;

FIG. 12 is a top view of the ball bearing drawer slide and center console lid/armrest base of the automotive center console lid/armrest slide bracing system of the invention; and

FIG. 13 is a perspective view of the lid/armrest cover of the automotive center console lid/armrest slide bracing system of the invention where the lid/armrest cover is in an open position.

### DETAILED DESCRIPTION OF THE PREFERRED EMBODIMENTS

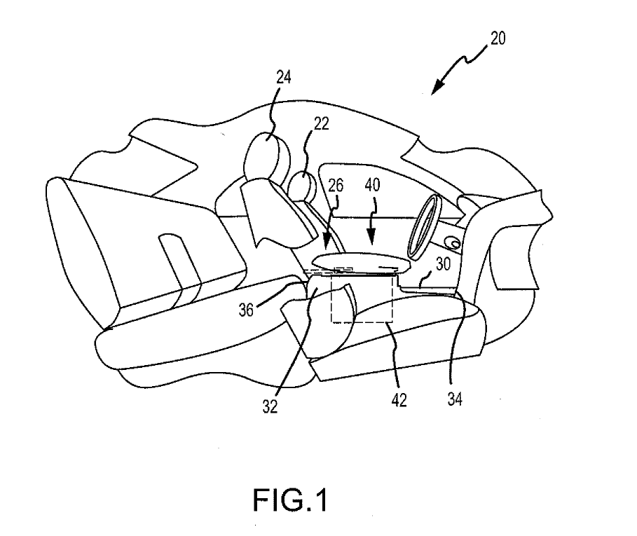

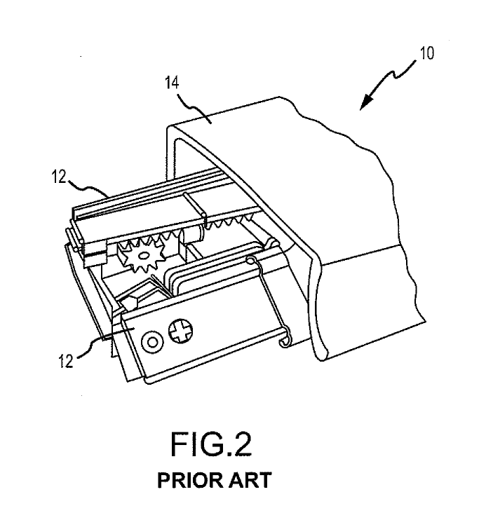

Referring now to the drawings wherein like reference numerals designate corresponding parts throughout the several views, FIGS. 1 and 3-13 illustrate various features of a center console lid/armrest slide bracing system 40 according to the invention.

Referring to FIG. 1, an environmental perspective view of an automotive interior 20 includes an exemplary center console 30 having center console lid/armrest slide bracing system 40. Although console 30 and system 40 is shown in an automotive vehicle, the system may be used in other vehicles such as trucks, vans, buses, or other suitable vehicles. In the embodiment illustrated, the console and assembly may be positioned between a driver seat 22 and a passenger seat 24 in automotive interior 20. Center console lid/armrest slide bracing system 40 may be generally elongated and rectangular in shape to fit in a space 26 between seats 22, 24. Console 30 may be secured to vehicle interior 20 by suitable means (not shown) and is fixed or stationary. Console 30 may include a bottom (not shown), side walls 32, a front end wall 34, a rear end wall 36, and a bin 42 disposed within these boundaries.

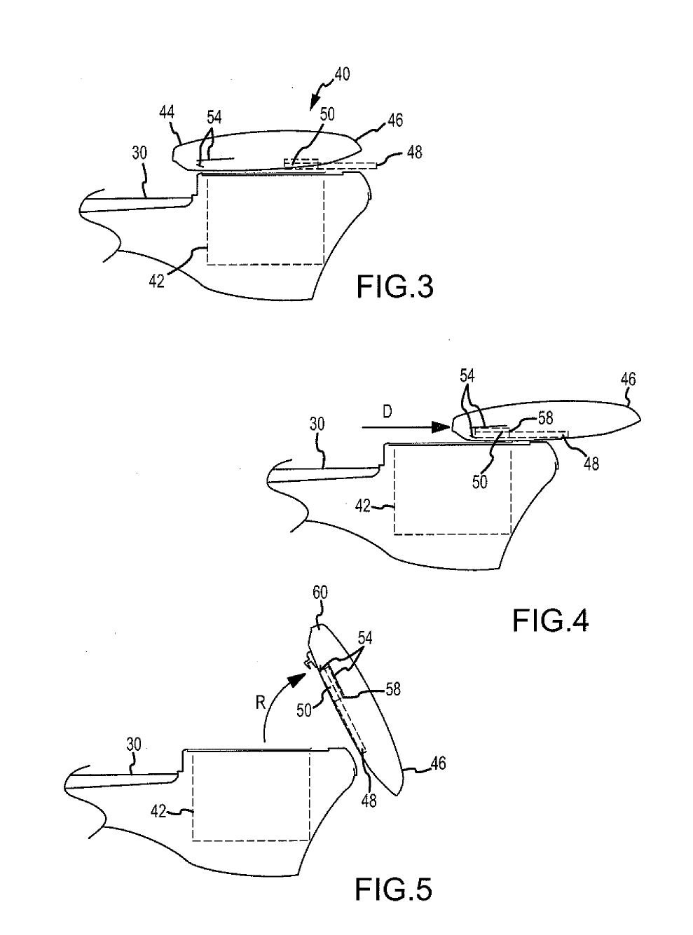

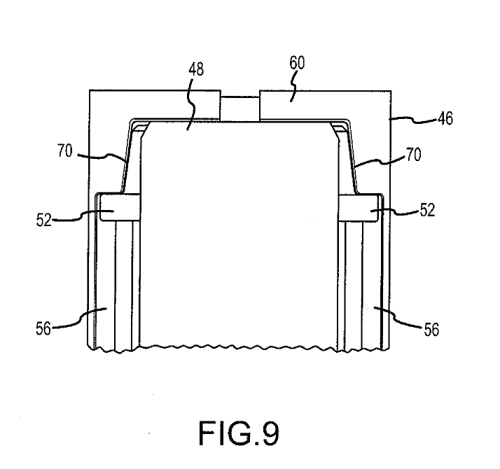

FIG. 3 is a side view of an embodiment of automotive center console lid/armrest slide bracing system 40 of the invention shown in a first operative position or home position or open position. FIG. 3 shows center console 30 having system 40 and bin 42. System 40 may include a center console lid/armrest 44 having a lid/armrest cover 46 coupled to or joined to a lid/armrest base 48. Lid/armrest base 48 may include ball bearing drawer slide 50, lid base protrusions 52 (see FIG. 8), angled wedge surfaces 54, and slide tracks 56 (see FIG. 9). The ball bearing drawer slide may be made of steel or aluminum metal or another suitable material. The lid/armrest and lid base protrusions may be made of plastic or another suitable material. The slide tracks may be made of plastic or another suitable material. The wedge surfaces are integral to the lid/armrest cover and the lid/armrest base which may both be made of plastic or another suitable material.

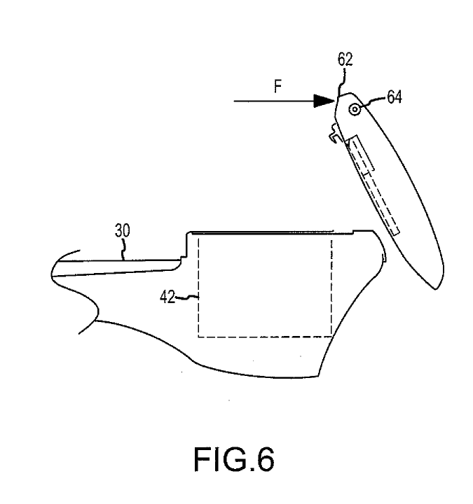

FIG. 4 is a side view of automotive center console lid/armrest slide bracing system 40 of FIG. 3 shown in a second operative position or partially open position to the forward portion of bin 42. The center console lid/armrest slides partially open in a rearward direction D of the vehicle. Wedge surfaces 54 on lid/armrest cover 46 engage matching wedge surfaces 58 on lid/armrest base 48, locking nose 60 of center console lid/armrest up and down for higher load requirements when open, in this way avoiding what would be an overload condition for a single ball bearing drawer slide, by transferring this load test directly from the lid/armrest cover to the lid/armrest base, when subjected to force F in FIG. 6. Similar additional wedge surfaces 54 on lid/armrest cover 46 and lid/armrest base 48 sides may lock nose 60 in a similar way for the high lateral load requirements when rotated open.

FIG. 5 is a side view of automotive center console lid/armrest slide bracing system 40 of FIG. 3 shown in a third operative or fully open position. Lid/armrest cover 46 opens in a rotational direction (R) upward. FIG. 6 is a side view of automotive center console lid/armrest slide bracing system 40 of FIG. 5 showing typical lid load application points or locations required in automotive testing. Lid load tests typically include an over opening load product requirement test and a lateral load product requirement test. FIG. 6 shows over opening force (F) at point 62 and lateral loads applied in both directions at point 64.

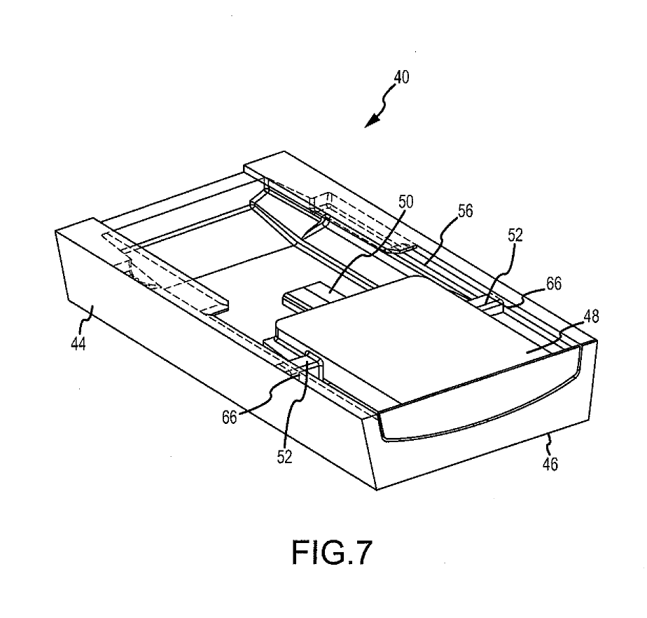

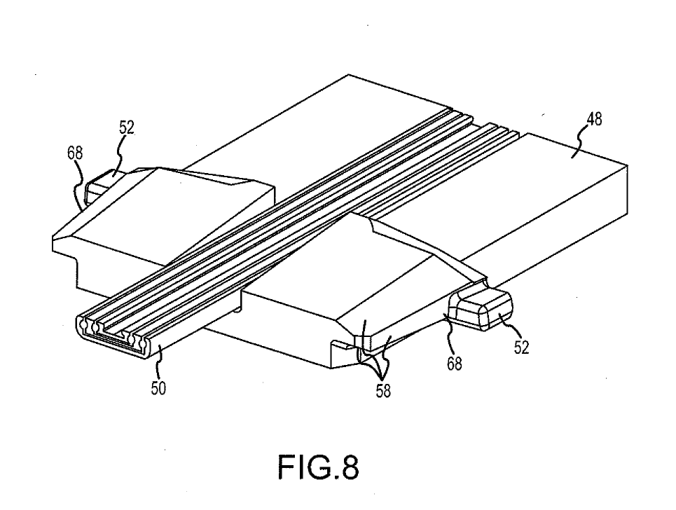

FIG. 7 is a perspective view of an embodiment of automotive center console lid/armrest slide bracing system 40 of the invention showing lid base protrusions 52 and grooves 66. FIG. 7 also shows center console lid/armrest 44, lid/armrest cover 46, lid/armrest base 48, ball bearing drawer slide 50, and slide tracks 56. Lid base protrusions 52 engage grooves 66 in lid/armrest cover 46 to form a slide track 56 for roll control.

FIG. 8 is a perspective view of an embodiment of the automotive center console lid/armrest slide bracing system 40 of the invention showing the wedge surfaces 58 on the lid/armrest base 48. FIG. 8 shows a view of the center console lid/armrest base 48 with ball bearing drawer slide 50 and at least one lid base protrusion 52 on each side 68 of lid/armrest base 48. Three wedge surfaces 58 may be provided on each side 68 of the lid/armrest base 48. A lid base protrusion 52 may be provided on each side 68 of the lid/armrest base 48. However, other suitable numbers of wedge surfaces and lid base protrusions may also be used.

FIG. 9 is a view of the center console lid/armrest from below, sectioned to show lid base protrusions 52 in slide tracks 56 of an embodiment of automotive center console lid/armrest slide bracing system 40. Lid base protrusions 52 on lid/armrest base 48 are shown in slide tracks 56. FIG. 9 also shows wedge braces or locks 70 that lock lid base protrusions 52 in place when the lid/armrest cover is open. Wedge braces or locks 70 provide a much more robust system in over opening force and lateral load tests, while simple slide tracks 56 and lid base protrusions 52 provide additional roll stability to the ball bearing drawer slide 50. Wedge braces or locks 70 (the three converging surfaces at the end of the lid/armrest's travel on both sides) lock lid/armrest cover 46 to lid/armrest base 48 along nose 60. This feature provides greatly increased strength in both the over opening load and lateral load product requirement tests. Slide tracks 56 (see two lid base protrusions 52 which extend into grooves 66 in lid/armrest cover 46 (see FIG. 7)) provide a further level of roll guidance to the lid/armrest in all slide positions.

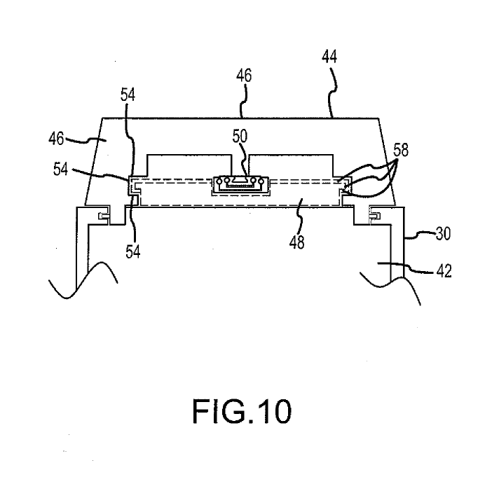

FIG. 10 is a sectional front view of one of the embodiments of the automotive center console lid slide bracing system 40 of the invention when lid/armrest cover 46 is in a closed position. FIG. 10 shows center console 30, bin 42, center console lid/armrest 44, lid/armrest cover 46, lid/armrest base 48 including wedge surfaces 54 on the lid/armrest cover, ball bearing drawer slide 50, and wedge surfaces 58 on lid/armrest base. FIG. 10 also shows wedge surface locations on the lid/armrest cover (wedge surfaces 54) and lid/armrest base (wedge surfaces 58). Wedge surfaces 58 on lid/armrest base 48 taper to the wedge surface locations to engage with the matching wedge surfaces 54 on lid/armrest cover 46.

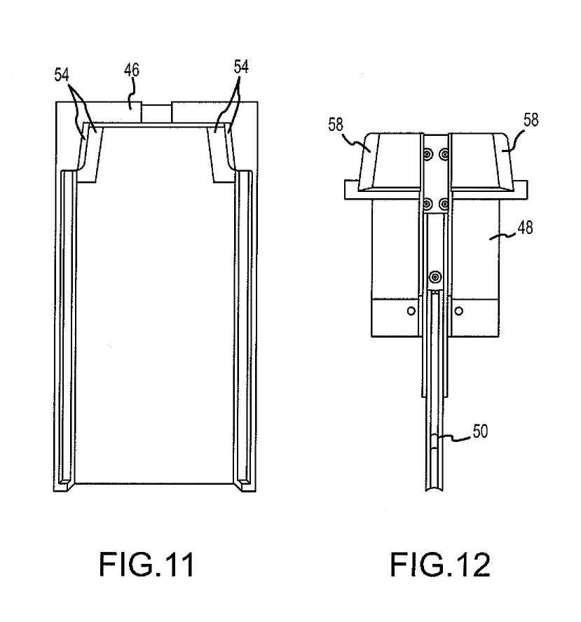

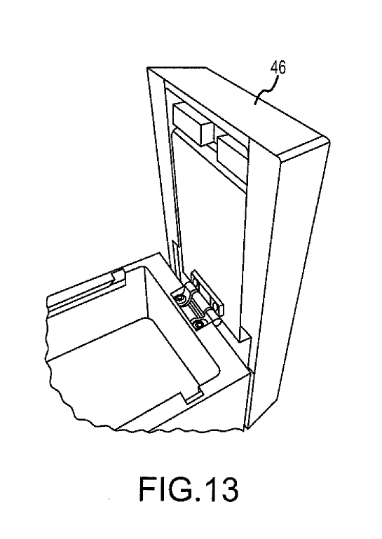

FIG. 11 is a bottom view of the underside of the lid/armrest cover 46 of the automotive center console lid/armrest slide bracing system 40 of the invention. FIG. 12 is a top view of ball bearing drawer slide 50 and center console lid/armrest base 48 of the automotive center console lid/armrest slide bracing system 40. FIG. 13 is a perspective view of lid/armrest cover 46 of automotive center console lid/armrest slide bracing system 40 of the invention where the lid/armrest cover 46 is in an open position.

Although several embodiments of this invention have been described above with a certain degree of particularity, those skilled in the art may make numerous alterations to the disclosed embodiments without departing from the scope of this invention. All directional references (e.g., upper, lower, upward, downward, left, right, leftward, rightward, top, bottom, above, below, vertical, horizontal, clockwise and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not as limiting. Changes in detail or structure may be made without departing from the invention as defined in the appended claims.

What is claimed is:

1. An automotive center console lid/armrest slide bracing system comprising:
a center console lid/armrest comprising:
a lid/armrest cover having a nose portion;
a lid/armrest base; and
a linear slide,
wherein the lid/armrest cover has at least one first wedge surface that engages at least one first corresponding wedge surface of the lid/armrest base when the center console lid/armrest is positioned generally rearward to lock the nose of the lid/armrest cover from movement in a first predetermined direction to resist higher loading requirements when open.

2. A system according to claim 1, wherein the lid/armrest cover first wedge surface is positioned inside the lid/armrest cover.

3. A system according to claim 1, wherein the first predetermined direction is an up and down direction when the center console lid/armrest is positioned in an automobile.

4. A system according to claim 1, wherein the slide is a ball bearing drawer slide.

5. A system according to claim 1, wherein the lid/armrest cover has at least one second wedge surface on each side of the inside of the lid/armrest cover that engages an at least one second corresponding second wedge surface on the lid/armrest base when the center console lid/armrest is positioned generally rearward to lock the nose of the lid/armrest cover from movement in a second predetermined direction to resist the higher loading requirements when open.

6. A system according to claim 5, wherein the second predetermined direction is a side to side direction when the center console lid/armrest is positioned in an automobile.

7. A system according to claim 1, wherein the center console lid/armrest has a plurality of grooves inside the lid/armrest cover, and the lid/armrest base has at least one lid base protrusion on each side of the lid/armrest base, wherein the lid base protrusions of the lid/armrest base engage the grooves in the lid/armrest cover to form a slide track to provide additional roll control.

8. A system according to claim 5, wherein the center console lid/armrest has a plurality of grooves inside the lid/armrest cover, and the lid/armrest base has at least one lid base protrusion on each side of the lid/armrest base, wherein the lid base protrusions of the lid/armrest base engage the grooves in the lid/armrest cover to form a slide track to provide additional roll control.

9. An automotive center console lid/armrest slide bracing system comprising:
a center console lid/armrest comprising:
a lid/armrest cover having a nose portion;
a lid/armrest base; and
a linear slide,
wherein the lid/armrest cover has at least one first wedge surface inside the lid/armrest cover that engages at least one first corresponding wedge surface on the lid/armrest base, when the center console lid/armrest is positioned fully rearward to lock the nose of the lid/armrest cover up and down to resist higher loading requirements when open.

10. A system according to claim 9, wherein the slide is a ball bearing drawer slide.

11. A system according to claim 9, wherein the lid/armrest cover has at least one second wedge surface on each side of the inside of the lid/armrest cover that engages an at least one second corresponding second wedge surface on the lid/armrest base, when the center console lid/armrest is positioned fully rearward to lock the nose of the lid/armrest cover side to side to resist the higher loading requirements when open.

12. A system according to claim 9, wherein the center console lid/armrest has a plurality of grooves inside the lid/armrest cover, and the lid/armrest base has at least one lid base protrusion on each side of the lid/armrest base, wherein the lid base protrusions of the lid/armrest base engage the grooves in the lid/armrest cover to form a slide track to provide additional roll control.

13. A system according to claim 11, wherein the center console lid/armrest has a plurality of grooves inside the lid/armrest cover, and the lid/armrest base has at least one lid base protrusion on each side of the lid/armrest base, wherein the lid base protrusions of the lid/armrest base engage the grooves in the lid/armrest cover to form a slide track to provide additional roll control.
